(19) United States
(12) Patent Application Publication
(10) Pub. No.: US 2015/0189653 A1
(43) Pub. Date: Jul. 2, 2015

(54) METHOD AND APPARATUS FOR ESTIMATING FREQUENCY OFFSET IN WIRELESS LOCAL AREA NETWORK (WLAN) SYSTEM

(71) Applicant: Electronics and Telecommunications Research Institute, Daejeon (KR)

(72) Inventors: Chang Wahn YU, Daejeon (KR); Hee Soo LEE, Daejeon (KR); Sok Kyu LEE, Daejeon (KR)

(21) Appl. No.: 14/581,953

(22) Filed: Dec. 23, 2014

(30) Foreign Application Priority Data
Dec. 31, 2013 (KR) 10-2013-0168541

(51) Int. Cl. H04W 72/04

(52) U.S. Cl. CPC H04W 72/0453

(57) ABSTRACT

Provided is a method and apparatus for estimating a frequency offset in a wireless local area network (WLAN), the apparatus including a field information combiner to combine a training sequence and a control field signal, and a frequency offset estimator to estimate a frequency offset based on information obtained by combining the training sequence and the control field signal.

### CROSS-REFERENCE TO RELATED APPLICATION

This application claims the priority benefit of Korean Patent Application No. 10-2013-0168541, filed on Dec. 31, 2013, in the Korean Intellectual Property Office, the disclosure of which is incorporated herein by reference.

### BACKGROUND

1. Field of the Invention

Embodiments of the present invention relate to technology for estimating a frequency offset in a system using a wireless local area network (WLAN).

2. Description of the Related Art

An orthogonal frequency division multiplexing (OFDM) system is widely used as a standard wireless communication method of a wireless local area network (WLAN), and digital video and digital audio broadcasting systems due to efficient use of a frequency band and strength against impulse noise and multipath fading.

However, performance of the OFDM system may be easily affected by a frequency offset caused by a Doppler effect occurring due to transmission and reception end relocation. The frequency offset may be normalized at an interval of a subcarrier and divided into an integer portion and a decimal portion based on a size.

An integer frequency offset may cause interference in relocating a subcarrier index of an OFDM symbol demodulated through a fast Fourier transform (FFT). A decimal frequency offset may fracture an intercarrier orthogonality and cause intercarrier interference. To prevent performance degradation of the OFDM system caused by the frequency offset, various frequency offset estimation methods using numerous symbols have been suggested.

Since overall system performance degradation may be caused by breaking a subcarrier orthogonality, performance of an OFDM system may be susceptible to a frequency offset occurring due to an operational irregularity of an oscillator included in a transmission and reception device and a Doppler shift. Thus, frequency offset estimation may be significant in the OFDM system.

A training sequence may be used to estimate a frequency offset in the OFDM system, and frequent research is being conducted on related matters. However, issues with respect to a performance change in a circumstance for each offset scheme may arise in frequency offset estimation method using only the training sequence and thus, a frequency offset estimation method using a training sequence corresponding to each circumstance such as a communication environment for each system may not be provided. Thus, in the frequency offset estimation method using only the training sequence, a frequency offset may not be precisely estimated, or an excessive amount of resources may be used to estimate the frequency offset.

### SUMMARY

According to an aspect of the present invention, there is provided an apparatus for estimating a frequency offset in a wireless local area network (WLAN) system, the apparatus including a field information combiner to combine a training sequence and a control field signal, and a frequency offset estimator to estimate a frequency offset based on information obtained by combining the training sequence and the control field signal.

The field information combiner may combine the control field signal with at least one of a very high throughput-long training field (VHT-LTF) reception complex storage value and an L-long training field (L-LFT) reception complex storage value transmitted through a wireless channel as the training sequence.

The field information combiner may combine the training sequence with at least one of a very high throughput-signal (VHT-SIG)-A reception complex storage value, a VHT-SIG-B reception complex storage value, and an L-signal (L-SIG) reception complex storage value transmitted through a wireless channel as the control field signal.

The field information combiner may use the control field signal corresponding to a determined training sequence.

When the determined training sequence is an L-LTF reception complex storage value, the field information combiner may use at least one of an L-SIG reception complex storage value and a VHT-SIG-A reception complex storage value as the control field signal.

When the determined training sequence is a VHT-LTF reception complex storage value, the field information combiner may use a VHT-SIG-B reception complex storage value as the control field signal.

The field information combiner may determine the control field signal to be one of “1” and “−1” based on the determined training sequence.

The field information combiner may calculate at least one of an addition operation value and a subtraction operation value with respect to the training sequence and the control field signal.

The frequency offset estimator may include a path selecting unit to compare the addition operation value and the subtraction operation value, and generate an output index value based on a result of the comparing.

The frequency offset estimator may include an output selecting unit to select a final output value to which a conjugate complex number value of the training sequence and the control field signal is applied based on the generated output index value, and output the selected final output value.

According to another aspect of the present invention, there is also provided a method of estimating a frequency offset in a WLAN, the method including combining, in a field information combiner, a training sequence and a control field signal, and estimating, in a frequency offset estimator, a frequency offset based on information obtained by combining the training sequence and the control field signal.

The combining may include combining the control field signal with at least one of a VHT-LTF reception complex storage value and an L-LFT reception complex storage value transmitted through a wireless channel as the training sequence.

The combining may include combining the training sequence and at least one of a VHT-SIG-A reception complex storage value, a VHT-SIG-B reception complex storage value, and an L-SIG reception complex storage value transmitted through a wireless channel as the control field signal.

The combining may include using the control field signal corresponding to a determined training sequence.

The combining may include using at least one of an L-SIG reception complex storage value and a VHT-SIG-A reception complex storage value as the control field signal when the determined training sequence is an L-LTF reception complex storage value.

The combining may include using a VHT-SIG-B reception complex storage value as the control field signal when the determined training sequence is a VHT-LTF reception complex storage value.

The combining may include determining the control field signal to be one of “1” and “−1” based on the determined training sequence.

The combining may include calculating at least one of an addition operation value and a subtraction operation value with respect to the training sequence and the control field signal.

The estimating may include comparing the addition operation value and the subtraction operation value, and generating an output index value based on a result of the comparing in a path selecting unit.

The estimating may include selecting a final output value to which a conjugate complex number value of the training sequence and the control field signal is applied based on the generated output index value, and outputting the selected final output value in an output selecting unit.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a frequency offset estimation apparatus according to an example embodiment;

FIG. 2 is a block diagram illustrating a frequency offset estimator according to an example embodiment;

FIG. 3 is a diagram illustrating a frequency offset estimation apparatus according to an example embodiment;

FIG. 4 is a diagram illustrating a data transmission configuration of a frequency offset estimation apparatus according to an example embodiment; and

FIG. 5 is a flowchart illustrating a data transmission configuration for multi-user transmission according to an example embodiment.

### DETAILED DESCRIPTION

Hereinafter, example embodiments of the present invention will be described with reference to the drawings.

When it is determined detailed description related to a related known function or configuration they may make the purpose of the present invention unnecessarily ambiguous in describing the present invention, the detailed description will be omitted here. Also, terminologies used herein are defined to appropriately describe the exemplary embodiments of the present invention and thus may be changed depending on a user, the intent of an operator, or a custom. Accordingly, the terminologies must be defined based on the following overall description of this specification. Like reference numerals refer to like elements throughout.

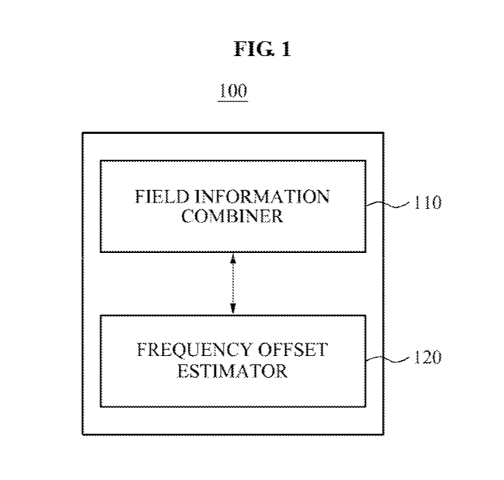

FIG. 1 is a block diagram illustrating an apparatus 100 for estimating a frequency offset according to an example embodiment. Hereinafter, the apparatus 100 for estimating a frequency offset may also be referred to as a frequency offset estimation apparatus 100.

Embodiments of the present invention may relate to technology for estimating a frequency offset additionally using information on a signal field in a system using a wireless local area network (WLAN), thereby improving overall system performance when compared to an existing frequency offset estimation technology using only a training sequence for frequency offset estimation.

To this end, the frequency offset estimation apparatus 100 may include a field information combiner 110 and a frequency offset estimator 120.

The field information combiner 110 may combine a training sequence and a control field signal. For example, the training sequence may include a very high throughput-long training field (VHT-LTF) reception complex storage value or an L-long training field (L-LFT) reception complex storage value transmitted through a wireless channel. The field information combiner 110 according to an example embodiment may combine the control field signal with at least one of the VHT-LTF reception complex storage value and the L-LTF reception complex storage value transmitted through the wireless channel.

In addition, the control field signal may include at least one of a very high throughput-signal (VHT-SIG)-A reception complex storage value, a VHT-SIG-B reception complex storage value, and an L-signal (L-SIG) reception complex storage value transmitted through a wireless channel. The field information combiner 110 according to an example embodiment may combine the training sequence with at least one of the VHT-SIG-A reception complex storage value, the VHT-SIG-B reception complex storage value, and the L-SIG reception complex storage value transmitted through the wireless channel.

Also, the field information combiner 110 according to an example embodiment may estimate a frequency offset in a WLAN system using the control field signal corresponding to a determined training sequence. For example, when the training sequence is an L-LTF, a signal that may be used in the control field signal may include an L-SIG or a VHT-SIG-A. When the training sequence is a VHT-LTF, the signal that may be used in the control field signal may include a VHT-SIG-B. Thus, when the determined training sequence is the L-LTF reception complex storage value, the field information combiner 110 according to an example embodiment may use at least one of the L-SIG reception complex storage value and the VHT-SIG-A reception complex value as the control field signal. Also, when the determined training sequence is the VHT-LTF reception complex storage value, the field information combiner 110 may use the VHT-SIG-B reception complex storage value as the control field signal.

The field information combiner 110 according to an example embodiment may determine the control field signal to be one of “1” and “4” based on the determined training sequence. For example, the control field signal may be provided in a form of a value of “1” or “−1” for use in a hard decision.

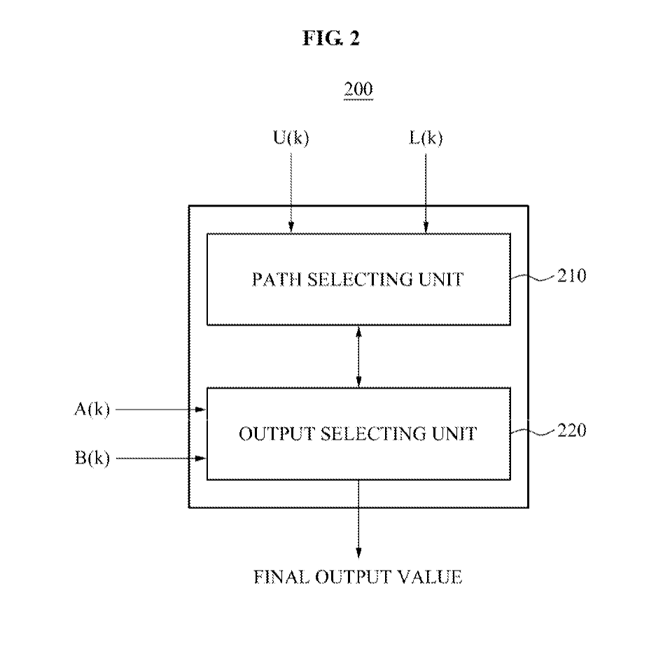

FIG. 2 is a block diagram illustrating a frequency offset estimator 200 according to an example embodiment.

The frequency offset estimator 200 may estimate a frequency offset based on information combined by a field information combiner. For example, the frequency offset estimator 200 may include a path selecting unit 210 and an output selecting unit 220.

The path selecting unit 210 according to an example embodiment may calculate at least one of an addition operation value and a subtraction operation value with respect to a training sequence and a control field signal. The output selecting unit 220 according to an example embodiment may compare the addition operation value and the subtraction operation value, and generate an output index value based on a result of the comparing. The frequency offset estimator 200 may select a final output value to which a conjugate complex number value of the training sequence and the control field signal is applied based on the generated index value, and output the selected final output value.

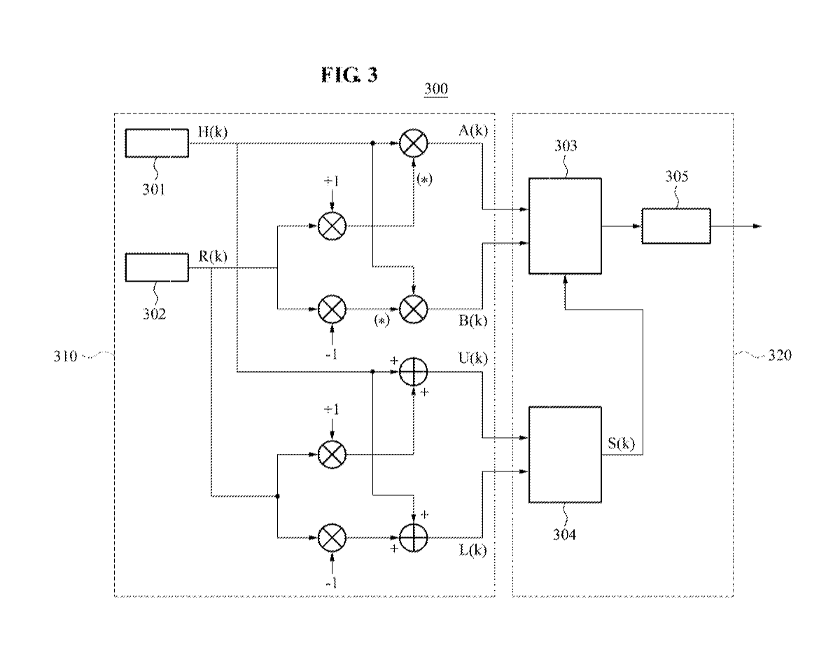

FIG. 3 is a diagram illustrating a frequency offset estimation apparatus 300 according to an example embodiment.

The frequency offset estimation apparatus 300 according to an example embodiment may combine a training sequence 301 and a control field signal 302 using a field information combiner 310. In this example, the training sequence 301 may include a VHT-LTF reception complex storage value or an L-LTF reception complex storage value transmitted through a wireless channel. The control field signal 302 may include at least one of a VHT-SIG-A reception complex storage value, a VHT-SIG-B reception complex storage value, and an L-SIG reception complex storage value transmitted through the wireless channel.

When the training sequence is the L-LTF reception complex storage value, a signal that may be used in the control field signal 302 may include the L-SIG reception complex storage value or the VHT-SIG-A reception complex storage value. When the training sequence 301 is a VHT-LTF, the signal that may be used in the control field signal may include the VHT-SIG-B reception complex storage value.

The field information combiner 310 according to an example embodiment may allocate “1” or “4” to the control field signal 302 based on information used by the control field signal 302. Also, the field information combiner 310 may use the allocated “1” or “−1” for the hard decision. For example, the field information combiner 310 according to an example embodiment may calculate Equation 1 for the hard decision.

U(k)=H(k)+R(k)

L(k)=H(k)−R(k) [Equation 1]

In Equation 1, H(k) may include the VHT-LTF reception complex storage value or the L-LTF reception complex storage value transmitted through the wireless channel, R(k) may include at least one of the VHT-SIG-A reception complex storage value, the VHT-SIG-B reception complex storage value, and the L-SIG reception complex storage value transmitted through the wireless channel.

A frequency offset estimator 320 according to an example embodiment may estimate a frequency offset based on information in which a training sequence is combined with a control field signal. For example, the frequency offset estimator 320 may include an output selecting unit 303 and a path selecting unit 304.

The field information combiner 310 may calculate at least one of an addition operation value and a subtraction operation value with respect to the training sequence and the control field signal. To this end, the path selecting unit 304 may compare the addition operation value and the subtraction operation value, and generate an output index value based on a result of the comparing. For example, the path selecting unit 304 may compare U(k) and L(k) of Equation 1, and select a path of a signal having a greater intensity.

Also, the output selecting unit 303 may select a final output value to which a conjugate complex number value of the training sequence and the control field signal is applied, based on the output index value generated by the path selecting unit 304.

For example, the field information combiner 310 may calculate Equation 2 as an input of the output selecting unit 303.

A(k)=H(k)×R*(k)

B(k)=−H(k)×R*(k) [Equation 1]

In Equation 2, H(k) may include the VHT-LTF reception complex storage value or the L-LTF reception complex storage value transmitted through the wireless channel, R(k) may include at least one of the VHT-SIG-A reception complex storage value, the VHT-SIG-B reception complex storage value, and the L-SIG reception complex storage value transmitted through the wireless channel. R*(k) denotes a conjugate complex number of R(k).

The output selecting unit 303 according to an example embodiment may select and output A(k) or B(k) of Equation 2 based on the output index value generated by the path selecting unit 304. An adder 305 may calculate an angle of an output value to estimate the frequency offset based on A(k) or B(k).

Using the frequency offset estimation apparatus 300, a reliability level in frequency offset estimation of a received signal may increase through a simple operation of a control signal.

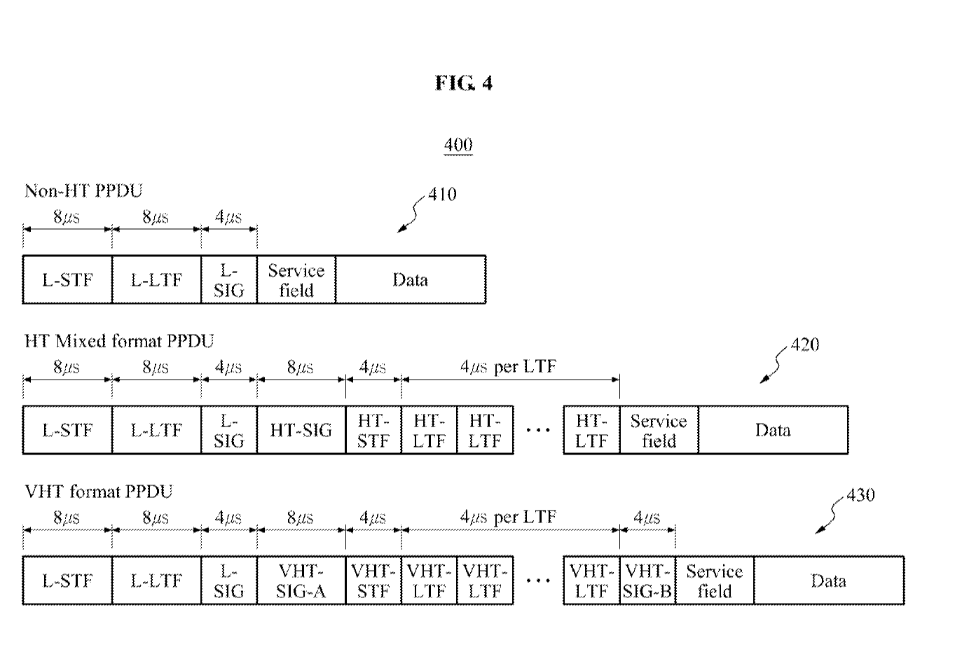

FIG. 4 is a diagram illustrating a data transmission configuration 400 of a frequency offset estimation apparatus according to an example embodiment.

An 802.11ac VHT wireless LAN physical layer configuration field using a channel estimation apparatus of embodiments of the present invention may be shown with reference to a first frame 410 of FIG. 4.

A system such as a WLAN may have a configuration of the first frame 410 of FIG. 4. The first frame 410 may be a presentation protocol data unit (PPDU) configuration of 11a/g corresponding to a non-high throughput (Non-HT) mode. A second frame 420 may be a PPDU configuration of 11n corresponding to a high throughput (HT) mode. A third frame 430 may be a PPDU configuration of 11ac corresponding to a VHT mode. To improve backward compatibility, each of the Non-HT mode, the HT mode, and the VHT mode may have an identical frame configuration to an L-SIG in the system such as a WLAN. Also, in the system, a high throughput-signal (HT-SIG) may be transmitted subsequent to the L-SIG for HT mode stations, and a VHT-SIG-A and a VHT-SIG-B may be transmitted subsequent to the L-SIG for VHT mode stations. In such a signal field, a determined number of bits, a determined modulation scheme, for example, a binary phase shift keying (BPSK), and a channel code rate, for example ½, may be used.

An L-LTF may be a training sequence for use in wireless channel estimation of the L-SIG and the VHT-SIG-A signal, and use a BPSK signal for a modulation scheme. A VHT-LTF may be a training sequence for use in wireless channel estimation of the VHT-SIG-B signal, and use the BPSK signal for a modulation scheme.

Each of the L-SIG, the VHT-SIG-A, and the VHT-SIG-B may be a control signal used to modulate a WLAN physical payer, and use the BPSK signal for a modulation scheme.

An 802.11ac WLAN access point (AP) and access terminal (AT) may be estimated based on a pilot subcarrier of a data signal, an LTF, and a short training field (STF) transmitted for frequency offset estimation. Since each of the L-SIG, the VHT-SIG-A, and the VHT-SIG-B uses an identical modulation scheme to the LTF signal, a reliability level of frequency offset estimation may increase through a simple operation in a reception configuration.

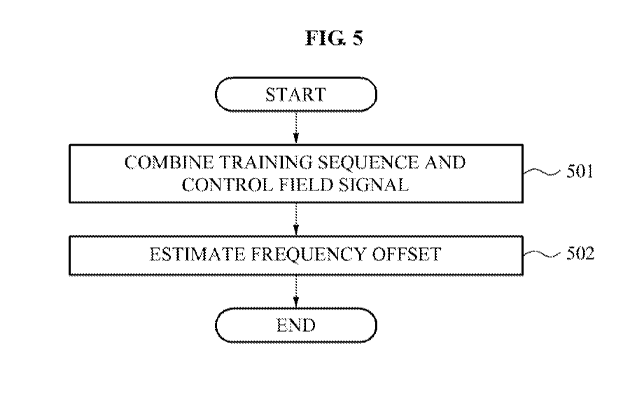

FIG. 5 is a flowchart illustrating a method of estimating a frequency offset according to an example embodiment. Hereinafter, the method of estimating a frequency offset may also be referred to as a frequency offset estimation method.

In operation 501, a field information combiner may combine a training sequence and a control field signal in the frequency offset estimation method according to an example embodiment.

For example, in the frequency offset estimation method, the control field signal may be combined with at least one of a VHT-LTF reception complex storage value and an L-LTF reception complex storage value transmitted through a wireless channel as the training sequence. Also, the training sequence may be combined with at least one of a VHT-SIG-A reception complex storage value, a VHT-SIG-B reception complex storage value, and an L-SIG reception complex storage value transmitted through the wireless channel as the control field signal.

In an example, the control field signal may be combined so as to correspond to a determined training sequence in the frequency offset estimation method according to an example embodiment. When the determined training sequence is the L-LTF reception complex storage value, at least one of the L-SIG reception complex storage value and the VHT-SIG-A reception complex storage value may be used as the control field signal. When the determined training sequence is the VHT-LTF reception complex storage value, the VHT-SIG-B reception storage value may be used as the control field signal.

As an example, the control field signal may be determined to be one of “1” and “−1” based on the determined training sequence so as to be used for hard decision.

In the frequency offset estimation method, at least one of an addition operation value and a subtraction operation value may be calculated with respect to the training sequence and the control field signal to combine the training sequence and the control field signal.

In operation 502, a frequency offset may be estimated by a frequency offset estimator based on information obtained by combining the training sequence and the control field signal. For example, in the frequency offset estimation method, the addition operation value may be compared to the subtraction operation value, and an output index value may be generated based on a result of the comparing. In this example, based on the generated index value, a final output value to which a conjugate complex number value is applied may be selected and output.

By using the frequency offset estimation method, a reliability level of frequency offset estimation may be improved based on control signal information in a training field information estimation scheme for the frequency offset estimation.

According to an aspect of the present invention, it is possible to improve a reliability level in frequency offset estimation based on control signal information in a training field information estimation scheme.

The method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy discs, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An apparatus for estimating a frequency offset in a wireless local area network (WLAN) system, the apparatus comprising:
a field information combiner to combine a training sequence and a control field signal; and
a frequency offset estimator to estimate a frequency offset based on information obtained by combining the training sequence and the control field signal.

2. The apparatus of claim 1, wherein the field information combiner combines the control field signal with at least one of a very high throughput-long training field (VHT-LTF) reception complex storage value and an L-long training field (L-LFT) reception complex storage value transmitted through a wireless channel as the training sequence.

3. The apparatus of claim 1, wherein the field information combiner combines the training sequence with at least one of a very high throughput-signal (VHT-SIG)-A reception complex storage value, a VHT-SIG-B reception complex storage value, and an L-signal (L-SIG) reception complex storage value transmitted through a wireless channel as the control field signal.

4. The apparatus of claim 1, wherein the field information combiner uses the control field signal corresponding to a determined training sequence.

5. The apparatus of claim 4, wherein when the determined training sequence is an L-LTF reception complex storage value, the field information combiner uses at least one of an L-SIG reception complex storage value and a VHT-SIG-A reception complex storage value as the control field signal.

6. The apparatus of claim 4, wherein when the determined training sequence is a VHT-LTF reception complex storage value, the field information combiner uses a VHT-SIG-B reception complex storage value as the control field signal.

7. The apparatus of claim 4, wherein the field information combiner determines the control field signal to be one of “1” and “4” based on the determined training sequence.

8. The apparatus of claim 1, wherein the field information combiner calculates at least one of an addition operation value and a subtraction operation value with respect to the training sequence and the control field signal.

9. The apparatus of claim 8, wherein the frequency offset estimator comprises a path selecting unit to compare the addition operation value and the subtraction operation value, and generate an output index value based on a result of the comparing.

10. The apparatus of claim 9, wherein the frequency offset estimator comprises an output selecting unit to select a final output value to which a conjugate complex number value of the training sequence and the control field signal is applied based on the generated output index value, and output the selected final output value.

11. A method of estimating a frequency offset in a wireless local area network (WLAN), the method comprising:
combining, in a field information combiner, a training sequence and a control field signal; and
estimating, in a frequency offset estimator, a frequency offset based on information obtained by combining the training sequence and the control field signal.

12. The method of claim 11, wherein the combining comprises combining the control field signal with at least one of a very high throughput-long training field (VHT-LTF) reception complex storage value and an L-long training field (L-LFT) reception complex storage value transmitted through a wireless channel as the training sequence.

13. The method of claim 11, wherein the combining comprises combining the training sequence and at least one of a very high throughput-signal (VHT-SIG)-A reception complex storage value, a VHT-SIG-B reception complex storage value, and an L-signal (L-SIG) reception complex storage value transmitted through a wireless channel as the control field signal.

14. The method of claim 11, wherein the combining comprises using the control field signal corresponding to a determined training sequence.

15. The method of claim 14, wherein the combining comprises using at least one of an L-SIG reception complex storage value and a VHT-SIG-A reception complex storage value as the control field signal when the determined training sequence is an L-LTF reception complex storage value.

16. The method of claim 14, wherein the combining comprises using a VHT-SIG-B reception complex storage value as the control field signal when the determined training sequence is a VHT-LTF reception complex storage value.

17. The method of claim 14, wherein the combining comprises determining the control field signal to be one of “1” and “4” based on the determined training sequence.

18. The method of claim 11, wherein the combining comprises calculating at least one of an addition operation value and a subtraction operation value with respect to the training sequence and the control field signal.

19. The method of claim 18, wherein the estimating comprises comparing the addition operation value and the subtraction operation value, and generating an output index value based on a result of the comparing in a path selecting unit.

20. The method of claim 19, wherein the estimating comprises selecting a final output value to which a conjugate complex number value of the training sequence and the control field signal is applied based on the generated output index value, and outputting the selected final output value in an output selecting unit.
